(19) United States
(12) Patent Application Publication
(10) Pub. No.: US 2008/0301556 A1
(43) Pub. Date: Dec. 4, 2008

(54) METHOD AND APPARATUS FOR DISPLAYING OPERATIONAL INFORMATION ABOUT AN ELECTRONIC DEVICE

(75) Inventors: Jay J. Williams, Skokie, IL (US); Carl M. Danielsen, Lake Zurich, IL (US); Renxiang Li, Lake Zurich, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/755,503

(22) Filed: May 30, 2007

(51) Int. Cl. G06F 3/048; G06T 13/00

(52) U.S. Cl. 715/706; 345/467; 345/474

(57) ABSTRACT

A method (100) and apparatus (300) for displaying operational information about an electronic device, that determines a change of an operational status of the electronic device, maps the operational status to at least one of an appearance characteristic and an action of an avatar (205, 210, 215, 220) related to the operational status changes the at least one of the appearance characteristic and action of the avatar in a manner related to the change of the operational status, and presents the avatar on a display (345) of the electronic device.

### RELATED APPLICATIONS

This application is related to a US application filed on even date hereof, having title “METHOD AND APPARATUS FOR DETERMINING THE APPEARANCE OF A CHARACTER DISPLAYED BY AN ELECTRONIC DEVICE”, having attorney docket number CML03970HI, and assigned to the assignee hereof

### FIELD OF THE INVENTION

The present invention relates generally to electronic devices and more specifically to displaying operational information about an electronic device.

### BACKGROUND

Embodied Conversational Agents (ECA's) and avatars are known as user interface elements, for example, in games and on the internet, in chat rooms and internet shopping websites. Their use is attractive to certain market segments. In some games, the avatar is affected in many ways (age, die, change their health, etc.) by events that arise within the game or by user input. For some non-game devices, such as a user interface for controlling a complex electronic device, avatars are used to interact with the user to provide assistance to the user. In one example, an animated dog is used to entertain a user while a search is being done. In another example, a program may collect past user selections of television programs and make recommendations based on them.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention. The figures and description explain various principles and advantages, in accordance with the embodiments.

FIG. 1 is a flow chart in which some steps of a method for displaying operational information about an electronic device are shown, in accordance with certain embodiments.

FIG. 2 is an illustration of an avatar as presented on a display, in accordance with certain embodiments.

FIG. 3 is a functional block diagram of an avatar control and display portion of an electronic device, in accordance with some of the embodiments.

FIG. 4 shows a diagram of a mapping, in accordance with certain of the embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail certain of the embodiments, it should be observed that the embodiments reside primarily in combinations of method steps and apparatus components related to displaying operational information about an electronic device. Accordingly, the apparatus, components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

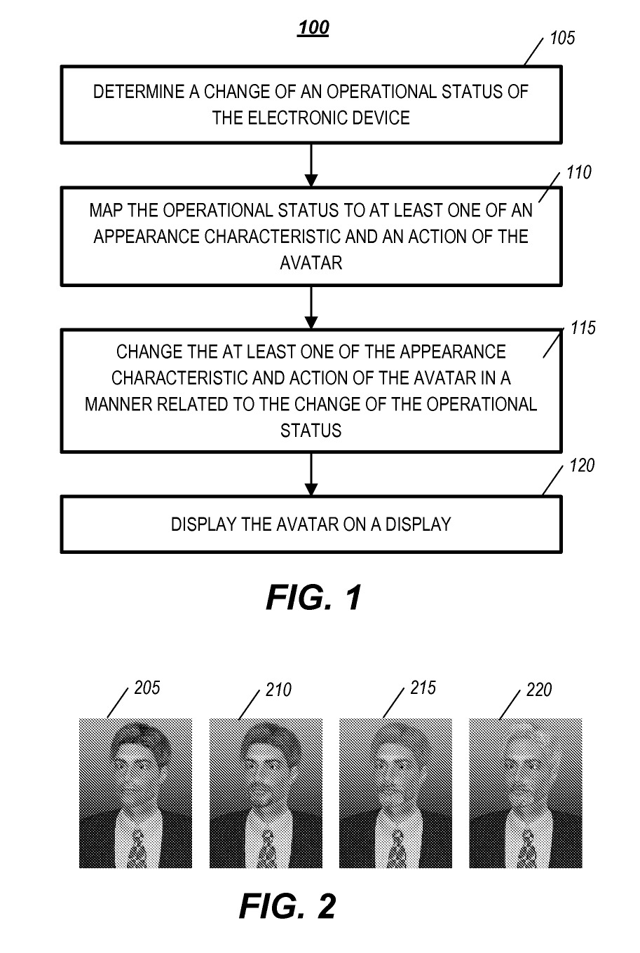

Referring to FIG. 1, some steps of a method 100 for displaying operational information about an electronic device are shown, in accordance with certain embodiments. At step 105, a change of an operational status of an electronic device is determined. The operational status of the electronic device is mapped, at step 110, to either one or both of an appearance characteristic and an action of an avatar related to that operational status. In some embodiments, the operational status of the electronic device may be also be mapped to a background change such as a background selection or effect. For example, there could be plurality of backgrounds to which operational states may be mapped, or there could a choice of effects, such as inversion, or 50% dimming of the background. At step 115, one or both of the appearance characteristic and action of the avatar is/are changed in a manner related to the change of the operational status, and the avatar is presented on a display of the electronic device at step 120. This description provides an overview of many of the embodiments that are described in this document. The electronic device can be any electronic device that is portable, such as, but not limited to, a cellular telephone, a remote control, a camera, a game box, or a navigation device, or other electronic devices, either commercial or military, such as vehicular controls, or televisions.

Referring to FIG. 2, an avatar as presented on a display is shown, in accordance with certain embodiments. The avatar's appearance characteristics that are related to age are changed in response to a condition of a battery of the electronic device. At stage 205, the avatar's appearance is that of a young man, which is mapped to a fully charged battery. In stages 210 and 215, the avatar's appearance is aged to represent a battery at ¾ charged (210) and ½ charged (215). At stage 220, the avatar is shown most aged, indicating a battery charge of ¼.

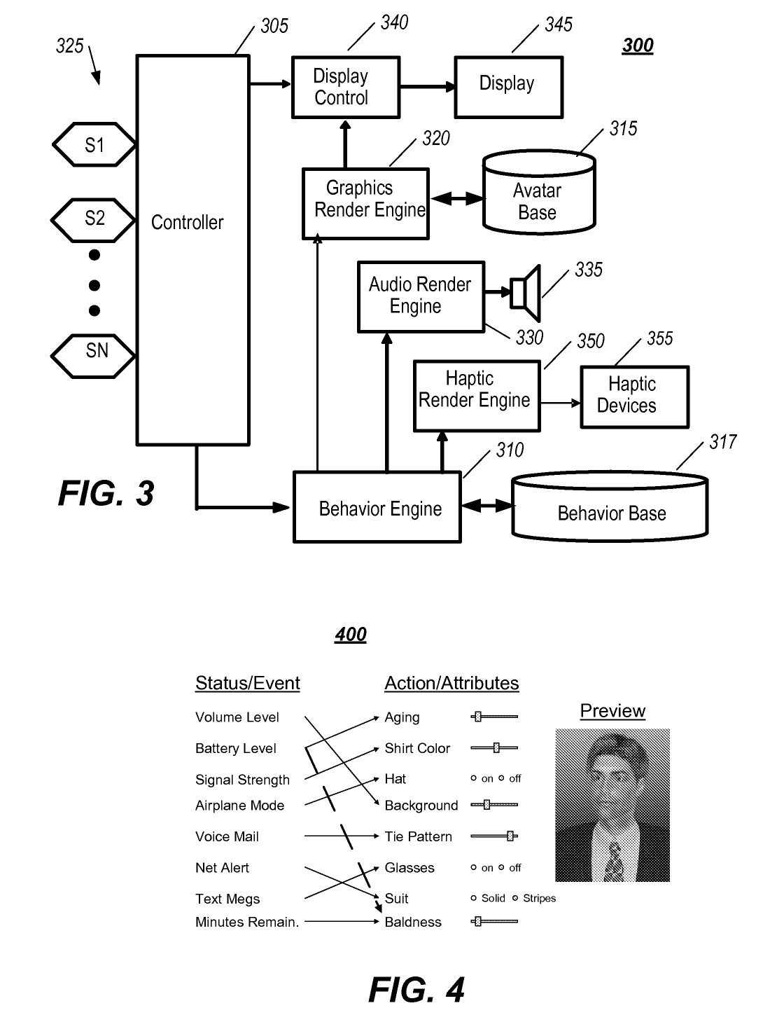

Referring to FIG. 3, a block diagram of an avatar control and display portion 300 of an electronic device is shown, in accordance with some of the embodiments. The avatar control and display portion 300 comprises a controller 305, a behavior engine 310, a behavior database 317, an avatar database 315, a graphics rendering engine 320, an audio rendering engine 330, an audio transducer 335, a haptic render engine 350, one or more haptic devices 355, a display controller 340 and a display 345. The controller 305 may be a processor that is controlled by programmed instructions that are uniquely organized as software routines that perform the functions described herein, as well as others. The controller 305 has operational inputs 325 identified as inputs S1, S2, . . . S_{N} from which changes to operational statuses of the electronic device are determined. In an example of a cellular telephone device, some examples of types of operational statuses are resource metrics, quality of service measurements, operational settings, and remaining service durations. Particular operational statuses include, but are not limited to: remaining battery capacity or (the inverse), used battery capacity (this was the example described above with reference to FIG. 2) (these are resource metrics—meaning internal resources of the electronic device), remaining memory capacity or used memory capacity (these are resource metrics), available bandwidth (a quality of service), volume setting (an operational setting), quantity of calling minutes left in the month (a remaining service duration). These inputs to the controller 305 may be event driven or monitored. For example, in some embodiments the battery may have an output that is event driven, causing the battery to generate the output when the battery capacity drops below ¾, ½, and ¼. In other embodiments, the battery capacity may be monitored in some embodiments, by sending a command to the battery to report its charge state.

When the controller 305 monitors an input or receives an event, the controller 305 has information available (for example, coded within the programmed instructions or stored in a memory that is accessed by the controller under control of the programmed instructions) that can determine when a significant change of status occurs (e.g., the battery capacity has fallen below a next quartile). In response to a change of status determined by the controller from a monitored input or from an event driven input, the controller 305 provides the new operational status or event to the behavior engine 310. The controller 305 send the operational status change to the behavior engine 310, which provides the new operational status or event to the behavior database 310, which uses the operational status or event to update a set of action or attribute states of the avatar from a previous set of states to a new set of states based on a user mapping of the operational status or event to changes of the action or attribute states of the avatar. The behavior database 317 generates new values that define a new graphic appearance of the avatar or avatar background, as well as associated audio and haptic signal values that are to be presented at the time the background and/or avatar's appearance changes. The mapping of the behavior database 317 is one that has been performed in response to user inputs to change these mappings. These values that define the appearance of the avatar and associated audio and haptic signals are returned to the behavior engine 310, which couples the background and avatar appearance values to the graphics rendering engine 320, couples the audio signal values to the audio render engine 330, and couples the haptic signal values to the haptic render engine 350. The graphics render engine 320 uses input obtained from the avatar database 315 and the background and avatar appearance values to generate image information, wherein the image includes a background and one (or more) avatar(s) that have been selected by the user from one or more in the database. The image may be combined with other display information (such as alerts or text information overlaid on the avatar and background) from the controller 305, or otherwise controlled by the controller 305 (such as substituting an alternative complete image, when appropriate) through the display control 340, which generates the composite data necessary to drive a display 345. The display 345 is typically, but not necessarily, physically joined with the rest of the avatar control portion of the electronic device. (For example, they may be separate when the electronic device is a cellular phone/camera/game device that has a head worn display).

The audio render engine 330 converts the audio signal values to signals that drive an audio transducer (typically a speaker) 335. For example, the avatar lips may move and an audio output may say “help me, I need energy” when the battery is critically low. The haptic render engine 350 converts the haptic signal values to signals that drive a haptic transducer (such as a vibrator) 355. For example, the electronic device may vibrate and the avatar put on its glasses when a text message is received.

User inputs (not shown) for manipulating the mappings stored in the behavior database 317 and for selecting from a default set of avatars stored in the avatar database 315 or downloading a new one into the avatar database 315 are received by the controller 305 and converted to database changes in the databases 315, 317. The user inputs are of course used for other purposes as well.

In the example described with reference to FIG. 2, the controller 305 would determine a status change of the battery to a new, lower quartile of capacity, and change the avatar from one of appearances 205, 210, 215 to a corresponding one of appearances 210, 215, 220, to show the battery is aging. This changed avatar may be presented, for example, in a corner of the display, or may occupy the complete display. The avatar may be displayed continuously for a long duration, changing its appearance or actions as operational status changes are detected. It will be appreciated that, in embodiments such as the one described for the battery, the change of the operational status that causes a change to the avatar is a change from a first range to a second range of the operational status.

Referring to FIG. 4, a diagram of a mapping is shown, in accordance with certain of the embodiments. The mapping performed by use of the behavior database may be determined by user interaction. In these embodiments, user-selected mapping of the operational status to appearances and actions of the avatar can be performed, or to an appearance of the background of the display (this aspect is not illustrated in detail in FIG. 4, but could be accomplished by adding a plurality of backgrounds in the list). In the example of FIG. 4, one means of interacting with the user is shown. A set of operational statuses and a set of appearance characteristics and a set of actions are shown, and in which the user links each (but not necessarily all) of the one or more statuses with one or more appearance characteristics and actions. In the example shown in FIG. 4, the dotted link illustrates an alternative situation in which the user has linked the “battery level” to both “baldness” and “aging” in which situation, the user would have chosen not to link “minutes remain” to anything because, for instance, the user has unlimited minutes). In some cases, a particular item may be classified as an appearance characteristic and an action, but others are fairly clearly one or the other. For example, two items that are not shown are smoking (a cigar, a cigarette, a pipe, etc) and shaking the head (e.g., “yes” or “no”; or “OK” “Not OK”) which are fairly clearly action items. The baldness is pretty clearly an appearance characteristic. The background is pretty clearly an appearance characteristic, and in the context of some of these embodiments is an appearance characteristic of the avatar. In some cases, the appearance characteristics may be categorized physically, such as by a body part color, a facial expression, apparel, a shape of a body part, or a combination of several of these. In other cases, the appearance characteristics may better categorized in terms of age, emotion, or race.

The mapping in FIG. 4, in addition to allowing a one to one mapping of operational status to appearance characteristic/actions, allows a user to select a setting or settings associated with the appearance characteristic/action. The setting may be one that alters the amount of change of appearance characteristic/action in response to a change in the operational status, or may select which of a predetermined set of appearance characteristic/actions are selected in response to a change in the operational status. The action or attributes may further include audible or haptic presentations, which in some embodiments may be independently mapped to the action/attributes with yet another set of user selectable mappings (not shown in FIG. 4). How to present such selections would be known to one of ordinary skill in the art. The mapping may be described as a stored user-determined relationship.

Although FIGS. 2 and 4 depict the avatar as an upper torso and head of a human or humanoid character, in some embodiments, the avatar could be a full body depiction of a human or a partial or full body depiction of an animal.

It will be appreciated that embodiments of the invention described herein may be comprised of one or more conventional processors and unique stored program instructions that control the one or more processors to implement, in conjunction with certain non-processor circuits, some, most, or all of the functions of the embodiments of the invention described herein. The non-processor circuits may include, but are not limited to, a radio receiver, a radio transmitter, signal drivers, clock circuits, power source circuits, and user input devices. As such, these functions may be interpreted as steps of a method to perform {replace with a technical description of the invention in a few words}. Alternatively, some or all functions could be implemented by a state machine that has no stored program instructions, or in one or more application specific integrated circuits (ASICs), in which each function or some combinations of certain of the functions are implemented as custom logic. Of course, a combination of these approaches could be used. Thus, methods and means for these functions have been described herein. In those situations for which functions of the embodiments of the invention can be implemented using a processor and stored program instructions, it will be appreciated that one means for implementing such functions is the media that stores the stored program instructions, be it magnetic storage or a signal conveying a file. Further, it is expected that one of ordinary skill, notwithstanding possibly significant effort and many design choices motivated by, for example, available time, current technology, and economic considerations, when guided by the concepts and principles disclosed herein will be readily capable of generating such stored program instructions and ICs with minimal experimentation.

In the foregoing specification, specific embodiments of the present invention have been described. However, one of ordinary skill in the art appreciates that various modifications and changes can be made without departing from the scope of the present invention as set forth in the claims below. As one example, there could be embodiments in which more than one avatar is used, either simultaneously on one display or as a group of two or more on one display. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for displaying operational information about an electronic device, comprising:
determining a change of an operational status of the electronic device;
mapping the operational status to at least one of an appearance characteristic and an action of an avatar related to the operational status;
changing the at least one of the appearance characteristic and action of the avatar in a manner related to the change of the operational status; and
presenting the avatar on a display of the electronic device.

2. The method according to claim 1, wherein the operational status is one of a resource metric, a quality of service measurement, an operational setting, and a remaining service duration.

3. The method according to claim 1, wherein the change of the operational status is from a first range to a second range of the operational status.

4. The method according to claim 1, wherein the mapping comprises determining by user interaction a stored user-selected mapping of the operational status to at least one of an appearance and an action of at least one of a set of appearance characteristics and a set of actions of the avatar.

5. The method according to claim 1, wherein the avatar comprises a rendering of a humanoid character.

6. The method according to claim 1, wherein the rendering comprises a head and upper torso portion of the humanoid character.

7. The method according to claim 1, wherein the appearance characteristic is at least one of a body part color, a facial expression, apparel, and a shape of body part.

8. The method according to claim 1, wherein the appearance characteristic is at least one of emotion, age, and race

9. The method according to claim 1, further comprising determining the manner of relationship between the change of operational status and change of appearance characteristic from a stored user-determined relationship.

10. The method according to claim 1, wherein the display is a display that is part of the electronic device.

11. The method according to claim 1, wherein the action is one of smoking and a shaking of the head.

12. The method according to claim 1, wherein the operational status is mapped to a change in the background of the display instead of or in addition to the at least one of an appearance characteristic and an action of an avatar related to the operational status.

13. An electronic device, comprising:
a processing system that includes memory for storing programmed instructions that control the processing system to:
determine a change of an operational status of the electronic device,
map the operational status to at least one of an appearance characteristic and an action of an avatar related to the operational status; and
change the at least one of the appearance characteristic and action of the avatar in a manner related to the change of the operational status; and
a display that presents the avatar on a display of the electronic device.
